(19) United States
(12) Patent Application Publication
(10) Pub. No.: US 2002/0060176 A1
(43) Pub. Date: May 23, 2002

(54) Static filtration media vessels

(76) Inventors: Bradley D. Mierau, Clearwater, FL (US); Henry C. Reid, Clearwater, FL (US); John E. Nohren JR., Clearwater, FL (US); Gerald J. Larsen, Clearwater, FL (US)

Correspondence Address: NIXON & VANDERHYE P.C., 8th Floor, 1100 North Glebe Rd., Arlington, VA, 22201-4714, US

(21) Appl. No.: 09/963,636

(22) Filed: Sep. 27, 2001

Related U.S. Application Data
(60) Provisional application No. 60/239,249, filed on Oct. 11, 2000.

(51) Int. Cl. B01D 39/14; B05D 3/12; B05D 3/06; B01D 27/06

(52) U.S. Cl. 210/94; 210/502.1; 210/472; 210/493.1; 210/497.1; 210/504; 210/505; 210/464; 427/553; 427/369

(57) ABSTRACT

An enhanced static filtration media may comprise a mat body comprising a non-woven of fibers that comply with 21 CFR 177.2260, and having a weight of about 4-7 oz./sq. ft.; a coating on the mat comprising about 100%-200% of the weight of the mat, and including, by weight, about 60-85% activated carbon, about 10-20% binder, and about 0-25% zeolite; and the media mat having an RDV/BV ratio of greater than about 0.4, and a porosity of greater than 90%. Various pitcher constructions make optimal use of the media. In some pitchers, the level of filtered water is easily viewed from the outside while the media is not visible from the outside.

### CROSS-REFERENCES TO RELATED APPLICATIONS

This application claims the benefit of U.S. Provisional Application Serial No. 60/239,249, which was filed Oct. 11, 2000, the disclosure of which is incorporated herein by this reference.

### BACKGROUND AND SUMMARY OF THE INVENTION

In co-pending application Ser. No. 09/506,575 filed Feb. 18, 2000 (Attorney Docket 13-90) and in co-pending provisional application Serial No. 60/200,014 filed Apr. 27, 2000 (Attorney Docket 13-94), the disclosures of which are hereby incorporated by reference herein, various pitchers, static treatment media, and methods and equipment for making static filtration media, are disclosed. According to the present invention static filtration media substantially the same as disclosed in the above co-pending applications is provided with additional features and modifications thereof. Also, according to the present invention a number of unique additional vessels are provided which significantly enhance effective utilization of the static filtration media earlier described, or that such as disclosed in European patent application 0402661 and U.S. Pat. No. 5,674,391, the disclosures of which are also hereby incorporated by reference herein.

The products and procedures according to the present invention provide enhanced utility in providing consumers with an alternative to tap water for better quality and taste, yet at a fraction of the cost of bottled waters.

According to one aspect of the present invention there is provided a vessel capable of holding and dispersing liquid, comprising: An outer body having a side comprising at least a portion of substantially transparent or translucent material, and a substantially closed bottom. A hollow inner body having at least a portion of substantially opaque material, and having an interior, the inner body spaced from the outer body to define a volume therebetween. Static liquid treatment media disposed within the inner body. A liquid passageway between the inner body interior and the volume allowing the flow of liquid from the inner body to the volume, but substantially precluding passage of static treatment media from the inner body to the volume. A neck or open end at a first end of the bodies opposite the substantially closed bottom through which liquid may enter the inner body interior. A closure for the neck or open end. And the bodies and static treatment media positioned so that liquid is visible in the volume, but so that the media is not visible, from exteriorly of the outer body.

The inner body is preferably substantially opaque where substantially aligned with the substantially translucent portion of the outer body, and preferably the volume has a substantially annular shape. For example, the inner and outer bodies are substantially circular in cross section and the inner body has an outer diameter of about 2-10% less than the inner diameter of the outer body. Preferably, at least about 80% (preferably substantially all of) the side of the outer body is of transparent material, such as glass or rigid or flexible plastic.

The vessel typically also comprises a substantially central vent tube extending from a second open end adjacent the vessel neck or open end to a first open end adjacent the liquid passageway central portion to provide appropriate venting action during pouring (or other expelling) from the vessel. The liquid passageway central portion is adjacent the outer body substantially closed bottom. Preferably the vent tube has a larger open cross sectional area adjacent the second end thereof than the first end thereof. For example, this may be provided by constructing the vent tube so that it has a flare from a point approximately ⅓ the length of the tube from the second open end to the second end. Also, the second end of the vent tube preferably has a hood to minimize or prevent liquid flow into the vent tube. The hood may be connected to an outer supporting element by a plurality of substantially radial support arms, and the outer supporting element operatively connected to the vessel adjacent the neck or open end thereof.

In addition to the static filtration media, the vessel may further comprise a conventional secondary particulate filter between the static treatment media and the liquid passageway. The secondary particulate filter may be positioned in other alternative locations, anywhere within the vessel to filter liquid prior to being poured or otherwise discharged from the vessel.

In a preferred embodiment the static filtration media comprises a non-woven mat of a material capable of meeting 21 CFR 177.2260, having a weight of between about 4-7 oz/sq. yd., and a coating comprising about 100- 200% of the weight of the mat, and including, by weight, or about 60-85% activated carbon, about 10-20% binder, and about 0-25% zeolite. Desirably the static filtration media has been compressed in one dimension about 25- 75% (e.g. about 40-60%) so as to provide a substantially uniform pore size, and has an RDV/BV ratio of about 0.3-0.8 (as measured by the cessation of streaming flow), preferably at least 0.4 and a porosity of at least 90%. The mat may be of polyester non-woven material and may be in roll or pleated form (such as disclosed in EP 0402661 or U.S. Pat. No. 5,674,391, which have been incorporated by reference herein). The fibers may be polyester, and the mat may substantially fill the inner body (except for where a particle filter is provided) and the mat may comprise about 5-20% zeolite.

According to another aspect of the present invention there is provided a vessel capable of holding and dispersing liquid, comprising: An outer body having a side and a substantially closed bottom. An inner body spaced from the outer body to define a volume therebetween. Static liquid treatment media disposed within the inner body. A liquid passageway between the inner body and the volume allowing the flow of liquid from the inner body to the volume, but substantially precluding passage of static treatment media from the inner body to the volume. A neck or open end at a first end of the bodies through which liquid may enter the inner body. A closure for the neck or open end; wherein the liquid passageway includes a substantially central portion adjacent the outer body substantially closed bottom. And a substantially central vent tube extending from a second open end adjacent the vessel neck or open end to a first open end adjacent the liquid passageway central portion to provide appropriate venting action during discharge from the vessel. The details of the features of the vessel may be as described above with respect to the first embodiment.

The closure may comprise a wide variety of conventional structures, such as a cap with a conventional manual valve (such as shown in U.S. Pat. No. 5,609,759), or the closure may comprise a substantially solid cap, or one having some other form of exit besides the valve, and connected to the neck or open end in any conventional manner, e.g. with a screw-on arrangement.

According to another aspect of the present invention there is provided a method of producing a static filtration media comprising: (a) Producing a porous mat of fibers that comply with 21 CFR 177.2260. (b) Applying a coating on the mat including activated carbon and binder. (c) Compressing the mat in one dimension about 25-75% so as to provide a more uniform pore size, by supplying a compression force. And (d) substantially maintaining the compression force until there is sufficient curing of the binder to minimize recovery of loft following release of the compression force.

Speeding the cure of the binder using heat, electromagnetic radiation, or some other mechanism, depending upon the particular binder involved. For example, if the binder were UV curable, then ultraviolet radiation would be intensely directed thereon during compression.

Typically (b) is practiced to applying a coating comprising about 100- 200% of the weight of the mat and including, by weight, about 60-85% activated carbon and about 10-20% binder. Also, (a) is typically practiced to produce a non-woven mat, and (a)-(d) are practiced to produce media having an RDV/BV ratio of at least 0.4 and a porosity of greater than 90%.

According to another aspect of the present invention a static filtration media is provided comprising a composite structure of activated carbon, ceramic ion-exchangers of either the class of zeolites, or amorphous gels comprised of sodium salts of aluminosilicates or titanium silicates, and a polyester substrate carrier in one of sponge or fiber form, compressed to form a treatment zone so that contaminate molecules suspended in water contained in the treatment zone are within about 0.5 mm of the carbon or zeolite. The media may be contained in (and substantially fill the operative portions of) a filter housing which holds between about 8 and 24 ounces of water, the treatment media removing at least about 70% of chlorine and at least about 90% of lead present in untreated water placed in the housing within about 0.1 to 5 (preferably about 0.5-2) minutes of filling of the filter housing.

According to another aspect of the present invention there is provided a static filtration media mat comprising: A mat body comprising a non-woven of fibers that comply with 21 CFR 177.2260, and having a weight of about 4-7 oz./sq. ft. A coating on the mat comprising about 100%-200% of the weight of the mat, and including, by weight, about 60-85% activated carbon, about 10-20% binder, and about 0-25% zeolite. And the media mat having an RDV/BV ratio of greater than about 0.4, and a porosity of greater than 90%.

The mat body preferably comprises primarily or substantially exclusively polyester fibers, and has a nominal thickness of about ⅛- 1 inch. Also the mat has unidirectional compression as described above, preferably between about 40-60%. The mat typically has voids distributed among the adsorptive sites with mean values of about 6-7 times 10⁻⁸ liters. And preferably comprises about 5-20% zeolite.

It is a primary object of the present invention to provide for enhanced effective filtration of water to remove chlorine, lead, and other contaminants therefrom, in an efficient and cost effective manner. This and other objects of the invention will become clear from an inspection of the detailed description of the invention and from the appended claims.

### BRIEF DESCRIPTION OF THE DRAWINGS

FIG. 1 is a side schematic cross-sectional view of an exemplary vessel according to the present invention;

FIG. 2 is a cross-sectional view taken along lines 2-2 of FIG. 1;

FIG. 3 is a cross-sectional view of the vessel of FIG. 1 taken at the top of the bottom of the vessel;

FIG. 4 is a schematic perspective view of an exemplary piece of filtration media mat according to the present invention;

FIG. 5 is a view like that of FIG. 1 of another embodiment of a vessel according to the present invention; and

FIGS. 6 and 7 are views like that of FIG. 5 only of still other modifications of vessels pursuant to the present invention.

### DETAILED DESCRIPTION OF THE DRAWINGS

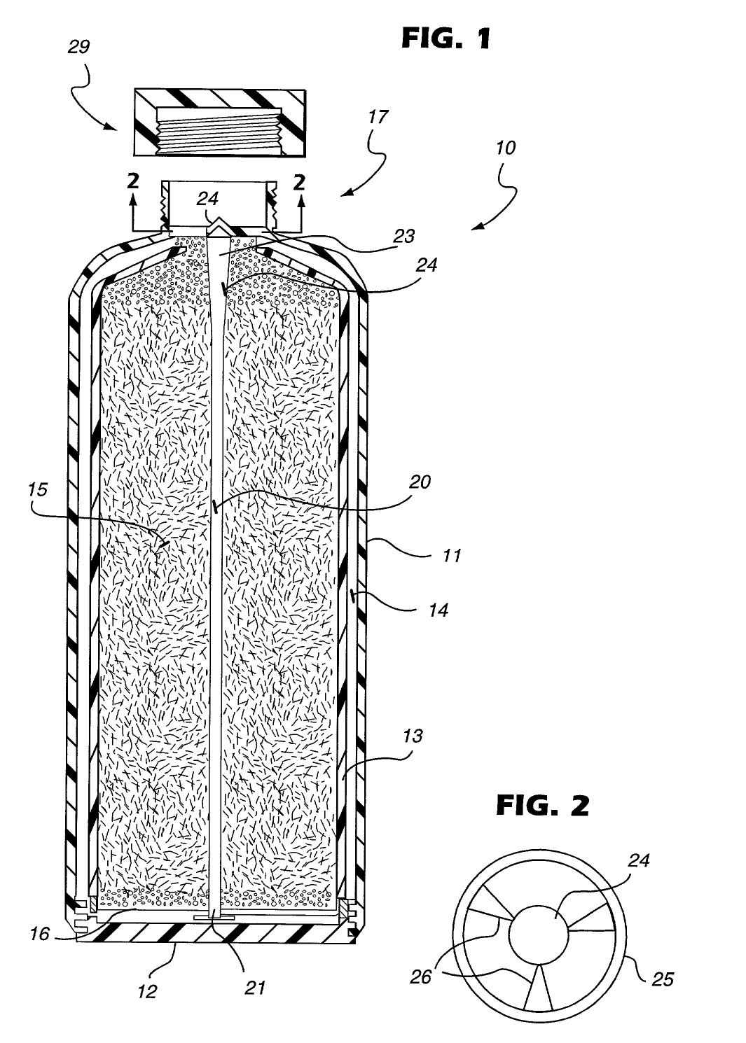

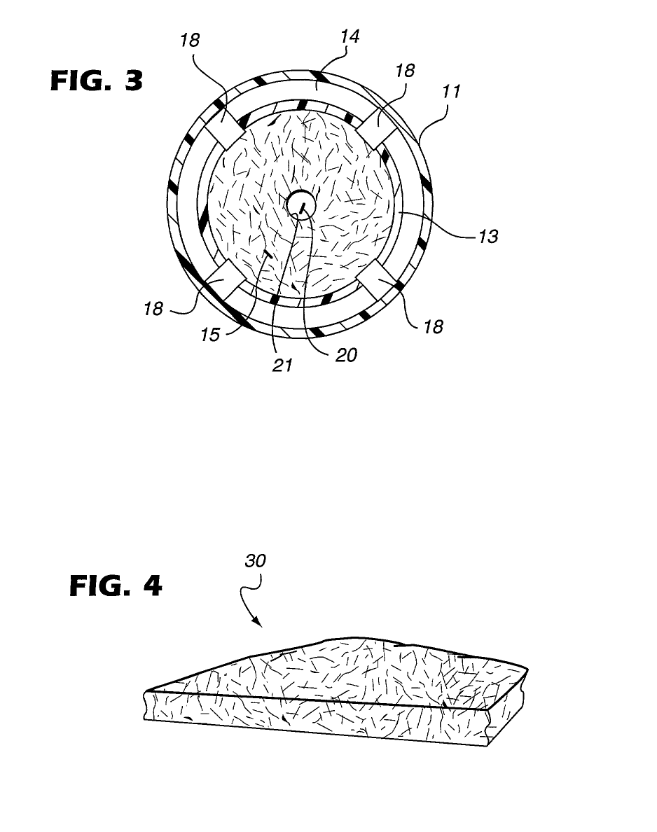

FIG. 1 generally illustrates a vessel 10 according to the present invention capable of holding and dispensing liquid, particularly water, such as tap water, that is treated in the vessel 10 and discharged from the vessel with chlorine, lead, and other contaminants removed. In the embodiment illustrated in FIGS. 1 through 3, the vessel 10 has an outer body having a side wall 11 of substantially transparent or translucent material, and a substantially closed bottom 12. The side wall may be a continuous side wall (e.g. a cylindrical side wall) or may have a number of flat surfaces, e.g. be polygonal in cross section, or have a wide variety of other shapes. The vessel 10 further comprises an inner body 13 having at least a portion thereof of substantially opaque material, the inner body spaced from the outer body to define a volume 14 therebetween. In the preferred embodiment illustrated in the drawings, as seen particularly from FIGS. 1 and 3, the bodies 11, 13 are substantially concentric, and the volume 14 is substantially annular, and the bodies 11, 13 are substantially circular in cross-section, and the inner body has an outer diameter (or cross-sectional area where not circular) of about 2-10% less than the inner diameter (or cross-sectional area if not circular) of the outer body 11. In the preferred embodiment substantially the entire outer body 11 (e.g. at least about 80% thereof) is transparent, such as of glass, or hard or flexible (squeezable) plastic, and the inner body 13 may be made of any suitable material, and is preferably substantially completely opaque.

The vessel 10 also includes a static liquid treatment media 15 disposed within the inner body 13, and a liquid passageway 16 between the inner body 13 interior and the volume 15 allowing the flow of liquid from the inner body 13 to the volume 14 but substantially precluding the passage of static treatment media from the inner body 13 to the volume 14.

The vessel 10 also includes a neck or open end 17 which is at a first end of the bodies 11, 13, opposite the substantially closed bottom 12, through which liquid may enter the inner body 13 interior. If the vessel 10 is filled with care, little if any water will flow into the annular volume 14 directly through the open end or neck 17, but rather will almost exclusively pass through the open end 17 into the interior volume of the inner body 13.

If desired, at the neck or open end 17 a secondary particulate filter of conventional construction may be provided, and such a filter may also or alternatively be provided at the bottom of the interior of the inner body 13, also whether or not a secondary particulate filter is provided at the bottom of the interior of the inner body 13, a plurality of support elements 18 (see FIG. 3 in particular) are preferably provided for supporting the inner body or shell 13 within the outer body/shell 11 and to define the liquid passageway 16. Alternatively the liquid passageway 16 could be defined at a location up from the bottom of the inner body 13.

The construction as described above has a number of important advantages, for example, compared to the vessels in EP 0402661 and U.S. Pat. No. 5,674,391. The bodies 11, 13 and the static treatment media 15 are positioned so that liquid is visible in the volume 14, so that the media 15 is not visible, from the exterior of the outer body 11. The transparent or translucent nature of the outer shell 11 is aesthetic, but even more importantly allows the user to see not only the level of liquid in the inner volume 14 (which will be substantially the same as in the interior of the inner shell 13), but also to see its clarity. If desired, a logo, or indicia, may be printed or otherwise provided on the exterior of the inner body 13, which is visible through the filtered water and the transparent outer shell 11.

Also, the vessel 10 preferably comprises a vent tube 20 having a first end 21 that is open in or adjacent the liquid passage 16, for example in a substantially central portion thereof when the liquid passage 16 has the construction adjacent the bottom 12 as illustrated in FIG. 1. The vent tube 20 has a second open end 23 adjacent the neck or open end 17 of the vessel 10. In the preferred embodiment illustrated in FIG. 1, the portion 24 of the vent tube 20 adjacent the second end 23 thereof (e.g. the top approximately ⅓ of the vent tube 20 as illustrated in FIG. 1) is flared so that it has a larger cross-sectional area at the second end 23 than does the majority of the vent tube 20, and particularly a greater cross-sectional area than at the first end 21. When the vent tube 20 is provided, then there is a non-interrupted stream of water that is delivered out of the neck or open end 17 during pouring or other discharge from the vessel 10 without the undesirable “glug, glug” sound often heard when venting is inadequate, and at a faster rate. The outer flare adjacent the second end 23 also significantly enhances the venting function.

In order not to diminish the venting action of the tube 20, preferably the tube 20 is provided at the second end 23 thereof with a hood 24 which has a conical shape so that water impacting thereon will tend to flow into the interior of the inner body 13 rather than into the vent tube 20, and the vent hood 24 is positioned by the substantially annular supporting structure 25 (see FIG. 2) with radially extending arms 26 so as to be just above the second open end 23. The annular support 25 can be adhesively secured, ultrasonically welded, (screw threaded) or in any other conventional manner affixed to the inner surface of the neck or open end 17 so as to properly position the hood 24 to deflect liquid from the vent tube 20 while allowing air to pass thereinto during discharge of liquid from the vessel 10.

The vessel 10 also preferably comprises a closure, such as the solid screw-on cap 29 illustrated in FIG. 1 for closing the top of the neck or open end 17. Alternatively the closure 29 could connect to the neck or open end 17 by a mechanism other than screw threads, and the closure 29 need not be solid but may include a manual valve (such as a conventional bicycle bottle valve), or other conventional construction.

While the static filtration media disclosed in EP 0402661 or U.S. Pat. No. 5,674,391 may be used as the static filtration media 15, in the preferred embodiment according to the invention static filtration media like that (or enhanced versions of) disclosed in copending applications Ser. No. 09/506,575 and Ser. No. 60/200,014, already incorporated herein by reference, may be utilized. Also, the media in EP 0402661 is not as effective as in the aforesaid applications, and as described further herein, for effectively filtering water to remove lead, chlorine, and other contaminants.

One desirable form of a static filtration media according to the present invention is the mat illustrated schematically at 30 in FIG. 4. In the preferred embodiment the mat 30 is non-woven of a material (such as polyester, either all polyester or a significant portion of polyester) capable of meeting 21 CFR 1.77.2260, having a weight of between about 4-7 oz/sq. yd., and comprising a coating of about 100-200% of the weight of the mat, and including, by weight, about 60-85% activated carbon, about 10-20% binder, and about 0-5% zeolite (e.g. about 5-20% zeolite), and/or other components depending upon the particular type of filtration desired. The philosophy behind, and scientific description of, a matrix according to the invention will now be set forth.

The extraparticle/extrafiber porosity of the treatment matrix may be closely controlled to optimize the functions of (1) Filling or replenishing, (2) Time in contact required to achieve contaminant results and, (3) Rate of pouring, or flow of treated water from the treatment media. Functions (1) and (3) are most easily achieved with a more open, less restrictive filter density. Function (2), contact time required is reduced as the density is increased.

The BET surface area (Journal of the American Chemical Society, vol. 60, p309, 1938) of a particular adsorbent is often used to reflect the number of binding sites available for contaminant removal per unit mass, and the ratio of pore volume to this surface area as an indicator of adsorption preferences based on molecular size of the contaminant. The porosity (pore volume per unit mass) of an adsorbent has also been used to provide an indication of adsorptive capacity. However, fluid contained within the pore structure of the adsorbent media is not generally accessible for removal from the filter, as capillary forces tend to hold it in place. Thus the overall porosity of the medium is not a useful descriptor of the treatment capacity of an adsorbent bed used in static treatment.

The only fluid (in particular water) which is available for use from any filtration device is that which is contained in the extra-particular or ‘bulk’ volume surrounding the adsorbent. In static treatment, this bulk volume must be sufficient to deliver a useful amount of fluid from the filter when drained, yet the distance between adsorbent particles must be small enough for the bulk fluid to approach equilibrium within a practical time.

A useful term to describe a filter medium, which can be operated in a static manner, is the ratio of “readily deliverable fluid volume” (RDV) to total bed volume (BV). Readily deliverable fluid volume is defined here as the volume of fluid, which will quickly drain from a decanted filter bed without the application of any external force (other than gravity). The word “quickly” in the previous definition refers to the time prior to the cessation of streaming flow. Static filters typically exhibit RDV/BV ratios from 30 to 80 percent.

Traditional filtration devices cannot be operated effectively in a static manner, because the extra-particular bulk volume in a packed bed is very small relative to the bed volume. The RDV/BV ratio of a granular activated carbon bed packed with 12×30-mesh carbon is typically 9 percent for a cylindrical bed around 8.5 inches in depth and 4.5 inches in diameter, as measured from cessation of streaming flow. The argument cannot be made that a packed bed overlaid with a column of fluid constitutes static treatment, as the mean distance between a fluid molecule and an adsorptive site is too large to allow for treatment within a reasonable amount of time. In addition, in such a system the tortuocity of the fluid path between the particles of the packed bed would hinder diffusion to the point of making the majority of the bed inaccessible to adsorption.

Density is achieved by compressing an open matrix to reduce the average distance between adsorbent particles, or individual void which holds the water, to be approximately 65 nL (or 6.5×10⁻⁸ liters) in volume. This equates to a RDV/BV ratio in the neighborhood of 63% for a cylindrical bed around 8.5 inches in depth and 4.5 inches in diameter. Larger voids are tolerated if residence time between use is not a priority. An RDV/BV ratio of at least about 0.4, and a porosity of at least 90%, are desired according to the invention.

Total effective treatment area is a function of the mass of the adsorbent contained in the treatment matrix. The composition of the static treatment media must be optimized to provide for a matrix with sufficient structural stability so as not to migrate during use, as well as containing enough adsorbent to effect a useful capacity for chemical removal. A matrix of sufficient rigidity to be compressible, yet not pack when wet, is created by using a 480 oz./cubic yd. non-woven polyester substrate coated with a mixture of activated carbon (and/or ion-exchange, zeolite compounds or other treatment media) and binder at a level of 50-200% by weight. Other substrate densities which are known to be effective include non-woven polyesters with densities ranging from 480 to 720 oz. / cubic yd., however much lower densities are applicable if steps are taken to support the media during hydrodynamic conditions.

In a preferred embodiment of the filtration media used in the practice of the invention primarily comprises a non-woven mat of polyester having a weight of about 4-7 oz. per square yard and which is impregnated with a water treatment media such as carbon, zeolite, etc. as described below, and is subject to compression at an appropriate time (either during manufacture with the coating, or at some earlier or later time), the amount of compression typically being between about 25-75%, more desirably between about 40- 60%, e.g. about 50%. The compression is such so as to make an optimal narrow void size distribution in the mat. For example, procedures and equipment such as shown in U.S. Pat. Nos. 3,019,127, 4,793,837, 4,963,431, or 5,161,686 (the disclosures of which are hereby incorporated by reference herein) may be utilized. Also constructions such as shown in Japanese patent publication 58146421 may be employed. While a polyester non-woven is preferred as the base material, virtually any synthetic or natural fibers that are not toxic and are capable of being formed into a porous non-woven, having the attributes set forth below, may be utilized. Also, if the appropriate material is used, a woven or knit construction, or the like, also may be employed for the base material.

The preferred method of manufacture of coated non-wovens such as those used which can be used in static filtration, are to draw rolls of non-woven fabric through a dipping bath where the materials the fabric is to be coated with are suspended. The bath preferably contains water treatment media such as activated carbon, ceramic cation-exchangers such as zeolites or amorphous gels such as sodium aluminosilicate or sodium titanium silicate, as well as a binder to secure them to the non-woven. The fabric is generally pulled through the bath where the fabric becomes saturated with coating material, and then through a series of rollers which squeeze excess coating from the fabric for return to the dipping bath. As the coated fabric exits the rollers it is then pulled through a drying oven where the binder is allowed to cure. Tension is usually maintained at the leading and trailing ends of the fabric to ensure that the fabric moves through the process in a uniform manner, and other agents may be added to the coated fabric prior to drying in order to facilitate curing of the binder. Important to the application of static filtration, the rollers described above serve not only to squeeze excess coating from the fabric, but also may perform the aforementioned compression induced collapse of the largest void spaces to yield a product with vastly improved performance.

To illustrate this point, consider two hypothetical media extremes, one with a large percentage of very small void spaces and one which predominates in large voids. Both media types fall within the description of the media in EP 0402661. In the first case the fluid would be held in close proximity to the sites of adsorption or reaction, facilitating rapid removal of contaminants from the water. The small volume voids would however experience capillary forces which would hold the water more tightly than in the larger voids, restricting the application to taller filters where a sizable column of water may be needed to supply the gravitational force needed to overcome this wicking action when the device is poured. In filters with a predominance of smaller voids, the capacity of the device to deliver water is reduced, even if the void volume is large. Conversely, in media with a preponderance of larger voids deliverable capacity is great and fill and pour rates are high, but the kinetics of removal are slow.

To achieve static treatment activated carbon, as well as other media, are affixed to randomly oriented fibers, or other highly porous substrates. In this invention the porous substrate is restricted to materials which are non-rigid, and subject to post impregnation compression. The starting materials are selected to provide a treatment media with a distribution of void volumes which is shifted toward the large side of the desired mean value of about 65 nL (nanoliters). The resulting matrix is compressed to preferentially collapse the larger void spaces to sizes which are closer to the desired mean, forming a narrower distribution of void sizes. The resultant treatment zones whereby the contaminant molecules contained within the zones are without about one millimeter, or less of a carbon, or other media element. Such a configuration provides for the movement of contaminant molecules to an active site on the media within a practical amount of time, without requiring convective flow. Diffusivities of common water contaminants are on the order of 5 * 10⁻⁶ cm²/ₛ, allowing treatment of the water within a time span of seconds to minutes, even without water flowing through the filter.

The effect of compression on results may be seen from the following tables:

TABLE 1
The theoretical effects of compression on performance.

Percent Contaminant Removal

| Time (min) | Uncompressed | Compressed |
|---|---|---|
| 0.0 | 30.63 | 32.86 |
| 0.5 | 70.16 | 75.97 |
| 1.0 | 78.68 | 85.26 |
| 1.5 | 83.44 | 90.08 |
| 2.0 | 86.53 | 92.93 |
| 2.5 | 88.70 | 94.75 |
| 3.0 | 90.33 | 95.98 |

TABLE 2
The effects of compression on performance.

Contaminant Concentration (μg/mLI)

| Compression Level (%) | Influent | Effluent |
|---|---|---|
| 12 | 185 | 30 |
| 37 | 185 | 25 |
| 51 | 185 | 8 |

The size and distribution of void spaces within the filter media has a marked affect on the performance of the filter with respect to contaminant removal. If one assumes a Weibull distribution of void sizes with parameter ‘a’of 20 and a parameter ‘b’ of 1.05, the kinetics of removal are shown in Table 1. Table 1 lists the percentage removal for the theoretical system at several time intervals. If the treatment objective is to reach 90% removal of a particular contaminant (as is required for certification by the NSF[2] for lead removal) improvement as a result of compression may be dramatic in terms of ease of use of the filter. In this example the uncompressed media takes twice as long to reach compliance.

Laboratory analysis of media performance under various levels of compression were performed to validate the theoretical model, with these results presented in Table 2. A controlled volume vessel was packed with media compressed from between 12 and 51% of its original thickness. Media which was midway through its useful life was used for testing at exposure times of three minutes, on order to yield effluent concentrations which were detectable by anodic stripping voltametry. The performance of the media for lead removal was shown to increase dramatically with compression, moving from a low tested value of 84% removal at 12% compression to a maximum tested value of 96% at about 50% compression.

Orientation of the media such that the plane of compression on fabrication is parallel to the flow path is critical to the successful fabrication of a filter. In EP 402661 we mention a spiral orientation which fits this criteria, but provide no justification for it other than implied convenience of manufacture. In subsequent work we have discovered that treatment efficiency and volume of production are greatly reduced if the plane of compression is perpendicular to the flow path. In the preferred method of preparing the static filtration media, non-woven is pulled through a coating tank, squeezed through rollers, and pulled through a drying oven. This process creates a product which has different surface characteristics on the two flat faces, and this alteration tends to cause water in the matrix to be retained when the faces are not oriented parallel to the flow path (for pouring and filling). The effect is that the manufacturing process creates a preponderance of smaller void regions near the surfaces of the felt which contact the rollers. If the filter media is oriented such that the plane surfaces are oriented perpendicular to the direction water flows during filling and pouring, the relatively compressed faces of the non-woven sheets inhibit initial wetting and fluid drainage from the filter. This decrease in drainage increases the percentage of less highly treated fluid which exits during a pouring step, as fluid held in regions more distal to the adsorption sites (which may undergo less treatment), would also preferentially drain from the filter.

TABLE 3
The effects of orientation of the media on performance.

| | Contaminant Effluent |
|---|---|
| Orientation Relative to Flow Path | Concentration (μg/L) |
| Perpendicular | 23 |
| Perpendicular | 18 |
| Parellel | 16 |
| Parellel | 13 |

Test results with static filtration media containing activated carbon as the sole adsorbent in orientations parallel and perpendicular to fluid flow are shown in Table 3 . A stack of carbon impregnated non-woven sheets were tested for lead removal in a test rig where the stack was compressed along the planar surface, with the sheets of media oriented either horizontally or vertically. The test rig consisted of a cube with an open top, to which challenge water was poured into and from. With the sheets in a horizontal orientation, the media in this orientation was able to reduce an influent concentration of lead from 150 μg/L to an average of 20.5 μg/L within 1 minute. Reorienting the stack of media so that the plane of the sheets was vertical, resulted in lead removal from 150 μg/L to an average of 14.5 μg/L in 1 minute. For this analysis, maintaining the flow path perpendicular to the plane of orientation resulted in a 29% improvement in performance as well as more rapid filter wetting.

The composition of a medium which possess optimum characteristics for providing a narrow void size distribution in the appropriate size-range with compression, is as follows. The numbers refer to a sheet of one square yard of coated material (polyester non-woven fabric 4 to 7 ounces/sq. yd), which is compressed to a thickness of approximately 8 mm. This media has been compressed in the planar dimension by approximately 50% as compared to uncompressed coated media.

Functional Coating equal to about 100 to 200% of the uncoated fabric weight, comprised of

Acrylic binder about 10 to 20% of the coating by weight

Coconut shell activated carbon about 60 to 85% of the coating by weight

Zeolite molecular sieve about 5 to 20% of the coating by weight

The preferred substrate for the fabric is polyester, due to its wetability and stability. Since the filters are designed for use in treating potable water, a substrate which is listed under Title 21 of the Code of Federal Regulations, Section 177.2260 (21CFR177.2260) is appropriate. The adsorbent material used to coat the substrate is typically ground to a powder in order to facilitate the coating process and improve the kinetics of adsorption, but static treatment media can be produced using particles of essentially any size so long as the RDV/BV requirements are not violated. The polyester base is formed into a non-woven fabric prior to coating using the same FDA compliant binder which is used to coat the fabric. The concentration of binder is critical to the stability of the media.

The final mat 30 may have a nominal thickness of between about ⅛-1 inch, and can be either in roll, spiral, or pleated form, and the method of producing a static filtration media according to the invention, such as utilizing the equipment illustrated and described in said copending application Ser. No. 09/506,575, there is provided: (a) Producing a porous mat (preferably a non-woven mat) of fibers that comply with 37 CFR 177.2260 (e.g. polyester). (b) Applying a coating (e.g. the coating described above) on the mat, including activated carbon and binder. (c) Compressing the mat in one dimension about 25-75% (e.g. about 40-60%) so as to provide a more uniform pore size, by applying a compression force (e.g. with rollers). And (d) substantially maintaining the compression force until there is sufficient curing of the binder to minimize recovery of loft following release of the compression force. The method may also further comprise speeding the cure of the binder using heat, electromagnetic radiation, or some other environmental factor depending upon the nature of the binder. In the method (a) through (d) are practiced to produce a media having an RDV/BV ratio of at least about 0.4 and a porosity of greater than 90%. If the vessel 10 holds between 8-24 ounces of water, the treatment media 15 (mat 30) removes at least about 70% (preferably about 90%) of the chlorine, and at least about 90% of the lead, present in the untreated water that flows into the vessel 10 through the neck or open end 17, within about 0.1-5 (preferably about 0.5-2) minutes of filling of the vessel 10.

Other treatment media may be utilized as the media 15. For example, any treatment may be utilized which comprises a composite structure of activated carbon, ceramic ion-exchangers of either the class of zeolites, or amorphous gels comprised of sodium salts of aluminosilicates or titanium silicates, and a polyester substrate carrier in one of sponge or fiber form, compressed to form a treatment zone so that contaminate molecules suspended in water contained in the treatment zone are within about 0.5 mm of the carbon or zeolite.

The media provided according to the invention preferably has voids distributed among the active sits with mean volumes around 6-7×10⁻⁸ liters. The media also preferably exhibits lead and chlorine reduction to levels required in NSF standards 42 and 53 for up to approximately 1600 treatment bed volumes.

While in the embodiment of FIG. 1 the vessel 10 is illustrated so that the bottom 12 of the outer body having a side wall 11 is integral with the side wall 11, the vessel can be constructed so that the bottom 12 is removable (e.g. screws off) as long as a tight seal is provided when the bottom 12 is attached to the side wall 11.

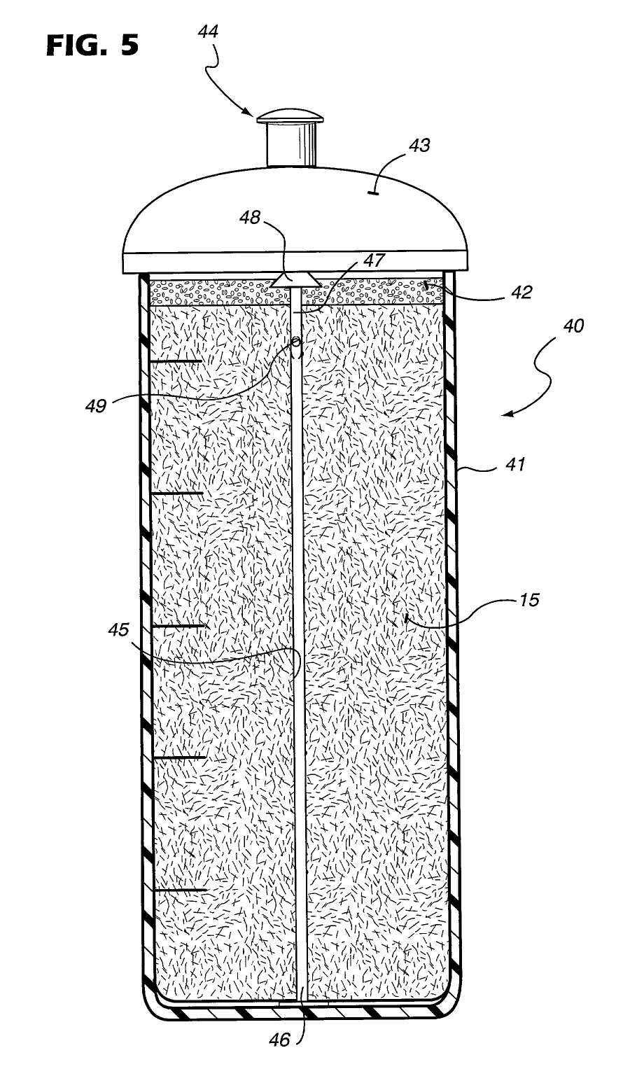

FIGS. 5 through 7 illustrate other embodiments of vessels that may be utilized with the static filtration media 15 according to the present invention in an effective manner.

The embodiment of FIG. 5 includes a vessel 40 which has a resilient plastic body bottle 41 as one of the main components thereof, the resilient plastic body 41 being substantially filled with the filtration media 15. A conventional fine particle filter 42 may be provided at the top of the plastic body 41 which allows water to pass into and out thereof. The bottle 41 has a removable cap 43, which preferably comprises a screw cap having a conventional pull-push valve 44 at the top thereof for dispensing liquid from the bottle 41.

It may be desirable to have an air relief tube 45 extending substantially through the center of the bottom end 46 of the tube 45 is preferably open, as is the top end 47, although it is preferably covered with a water deflector or snorkel 48 to prevent water from flowing directly into the tube 45 and thus occluding it when the vessel 40 is being filled (with the cap 43 removed). The water deflector 48 is attached to the open top 47 of the tube 45 by a plurality of support arms so that water moving downwardly is deflected by the element 48, but air can easily pass under the element 48 into the open end 47 of the tube 45.

If desired, an optional conventional flow restricting valve 49 may be provided in the tube 46 which can impose a minimum residence time for water to be treated.

When utilizing the configuration of FIG. 5, the cap 43 is removed and water flows downwardly into the bottle 41 in contact with the media 15. When the cap 43 is screwed back on and the valve 44 opened, the bottle 41 may be squeezed so as to expel water through the fine particulate filter 42 through the open valve 44. In this situation it is important that the binder of the static filtration media 15 have sufficient flexibility so that the media 15 recovers its shape and uniformity following each duty cycle. The air relief tube 45 allows the air to vent from the media 15 when the bottle 41 is being filled, the air moving up through the tube 45 to pass underneath the water deflector 48 and then out of the open top of the bottle 41. If a vent tube 41 is not employed, the bottle 41 should be repeatedly flexed during filling to force trapped air out of the lower portions of the media 15.

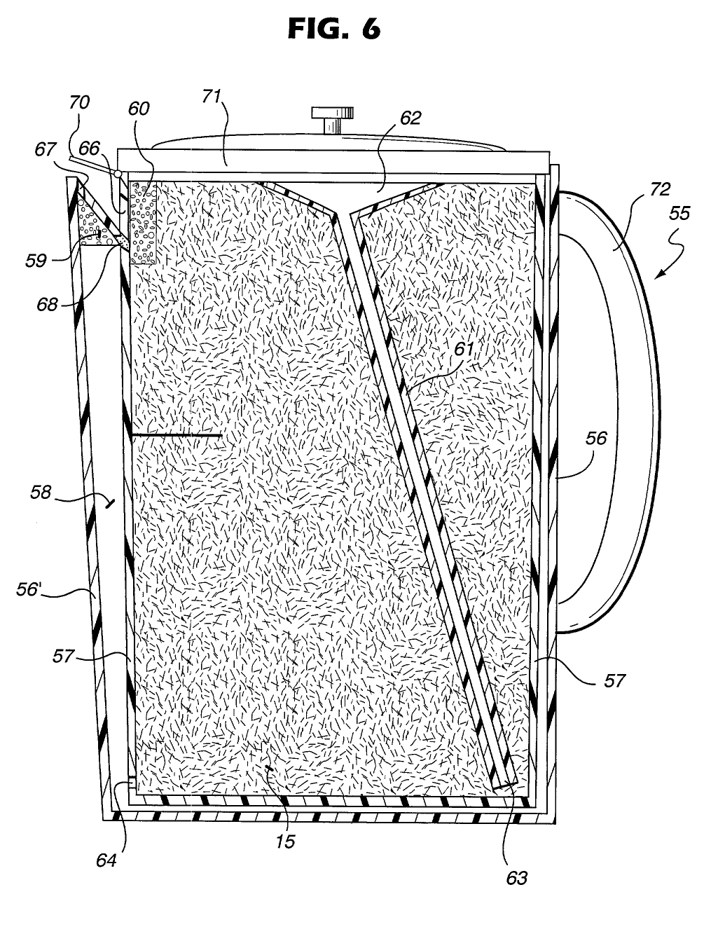

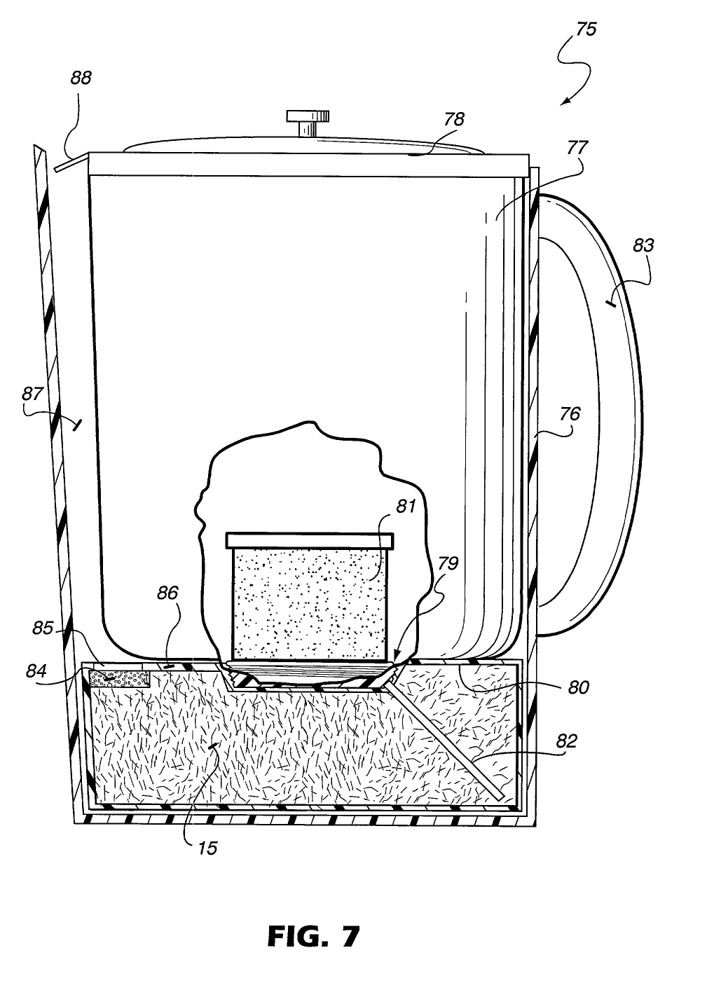

In the embodiment illustrated in FIG. 6, a vessel 55 is provided having an outer body 56 and an inner body 57, with a spout portion 56′ of the outer body 56 preferably of transparent material so as to provide a fill level indicator and to also illustrate the clarity of the water in the volume 58 between the inner body 57 and the spout 56′. In this embodiment conventional particle filters 59, 60 may be placed as desired. As in the other embodiments the static filtration media 15 is disposed in the interior body 57 and substantially fills it, although it is desirable to include a fill tube 61 having an upper conical/funnel shaped fill port 62 to which liquid flows when the vessel 55 is being filled, being discharged out the open bottom 63 of the fill tube 61 to move into the media 15. One or a plurality of ports 64 may be provided in the vessel body 57 to allow treated liquid to flow into the volume 58 to provide the functions indicated above. Liquid can then be poured out of the vessel 55 through a relatively large opening 66 adjacent to the particle filter in the top portion of the inner body 57 adjacent the spout 56′, and through the opening 67 in the divider 68 between the volume 58 and the opening 66, the opening 67 adjacent the particle filter 59. A hinged exit flap 70 may be provided attached to the removable top 71 so that when the user grasps the handle 72 of the vessel 55 and tilts it, the flap 70 will pivot open while water flows through the openings 66 and 67 out of the vessel 55 to be dispensed.

In the embodiment of FIG. 7, a vessel 75 is provided having a static filtration media 15 defined in a bed that only takes up a small portion of the interior volume of the vessel 75, preferably adjacent the bottom thereof as illustrated in FIG. 7. In this embodiment the outer body 76 has an independent raw water reservoir housing 77 that can be removed from the outer housing 76 and replaced, or the removable cover 78 may simply be removed and water poured therein. The raw water reservoir 77 has an opening 79 in the bottom 80 thereof, and a protozoa filter 81 is mounted in the opening 79. For example, filter 81 can be threaded into the opening 79, and an O-ring or like seal may be provided. Raw water must then pass through the conventional protozoa filter 81 when the raw water passes through the filter 81 it flows through the water entry tube 82 into contact with the static filtration media 15. There, lead and chlorine and the like are removed.

When a user grasps the handle 83 of the vessel 75 and tilts it, treated liquid flows through the static filtration media 15, preferably through the final particle filter 84, through the opening 85 in the solid wall 86 of the canister containing the filtration media 15, and then into the pour reservoir 87, moving past the hinged flap 88 to be dispensed. While the reservoir 77 is preferably removable from the vessel 75, it is maintained in place (by any suitable locating or latching mechanisms, conventional per se) within the vessel 75 until it is desired to remove it.

It will thus be seen that according to the present invention a very simple yet effective static filtration media, and various vessels optimally using the static filtration media, have been provided. While the invention has been herein shown and described in what is presently conceived to be the most practical and preferred embodiment thereof it will be apparent to those of ordinary skill in the art that many modifications may be made thereof within the scope of the invention, which scope is to be accorded the broadest interpretation of the appended claims so as to encompass all equivalent structures and devices and methods. Also, each of the numerical ranges set forth above specifically includes all narrower ranges within a broad range. For example the RDV/BV ratio range of between 0.3-0.6 includes 0.35-0.55, 0.4-0.58, and all other narrower ranges within the broad range.

What is claimed is:

1. A vessel capable of holding and dispersing liquid, comprising:
an outer body having a side comprising at least a portion of substantially transparent or translucent material, and a substantially closed bottom;
a hollow inner body having at least a portion of substantially opaque material, and having an interior, said inner body spaced from said outer body to define a volume therebetween;
static liquid treatment media disposed within said inner body;
a liquid passageway between said inner body interior and said volume allowing the flow of liquid from said inner body to said volume, but substantially precluding passage of static treatment media from said inner body to said volume;
a neck or open end at a first end of said bodies opposite said substantially closed bottom through which liquid may enter said inner body interior;
a closure for said neck or open end; and
said bodies and static treatment media positioned so that liquid is visible in said volume, but so that said media is not visible, from exteriorly of said outer body.

2. A vessel as recited in claim 1 wherein said inner body is substantially opaque where substantially aligned with said transparent or translucent portion of said outer body.

3. A vessel as recited in claim 2 wherein said volume has a substantially annular shape.

4. A vessel as recited in claim 3 wherein said inner and outer bodies are substantially circular in cross-section and wherein said inner body has an outer diameter about 2-10% less than an inner diameter of said outer body.

5. A vessel as recited in claim 1 wherein said static filtration media comprises a non-woven mat of a material capable of meeting 37 CFR 177.2260, having a weight of between about 4-7 oz/sq. yd., and a coating comprising about 100-200% of the weight of the mat, and including, by weight, about 60-85% activated carbon, about 10-20% binder, and about 0- 25% zeolite.

6. A vessel as recited in claim 5 wherein said static filtration media has been compressed in one dimension about 25-75% so as to provide a substantially uniform pore size.

7. A vessel as recited in claim 6 wherein said compression is between about 40-60%.

8. A vessel as recited in claim 6 wherein said media has an RDV/BV ratio of between about 0.3-0.8 (as measured by the cessation of streaming flow) and a porosity of at least 90%.

9. A vessel as recited in claim 6 wherein said mat is of polyester non-woven material.

10. A vessel as recited in claim 6 wherein said mat substantially fills said inner body.

11. A vessel as recited in claim 10 wherein said mat is in roll or pleated form.

12. A vessel as recited in claim 6 wherein said mat comprises about 5- 20% zeolite.

13. A vessel as recited in claim 1 wherein said liquid passageway includes a substantially central portion adjacent said outer body substantially closed bottom; and further comprising a substantially central vent tube extending from a second open end adjacent said vessel neck or open end to a first open end adjacent said liquid passageway central portion, to provide appropriate venting action during discharge from said vessel.

14. A vessel as recited in claim 13 wherein said vent tube has a larger open cross-sectional area adjacent the second end thereof than the first end thereof.

15. A vessel as recited in claim 14 wherein said vent tube has a flare at a point approximately ⅓ the length of said vent tube from said second open end to said second end.

16. A vessel as recited in claim 13 wherein said first end of said vent tube has a hood to minimize or prevent liquid flow into said vent tube.

17. A vessel as recited in claim 16 wherein said hood is connected to an outer supporting element by a plurality of substantially radial support arms, and said outer supporting element operatively connected to said vessel adjacent said neck or open end thereof.

18. A vessel as recited in claim 1 further comprising a secondary particulate filter between said static treatment media and said liquid passageway.

19. A vessel as recited in claim 1 wherein at least about 80% of said side of said outer body is of transparent material.

20. A static filtration media mat comprising:
a mat body comprising a non-woven of fibers that comply with 21 CFR 177.2260, and having a weight of about 4-7 oz./sq. ft.;
a coating on said mat comprising about 100%-200% of the weight of said mat, and including, by weight, about 60-85% activated carbon, about 10- 20% binder, and about 0-25% zeolite; and
said media mat having an RDV/BV ratio of greater than about 0.4, and a porosity of greater than 90%.

21. Media as recited in claim 20 wherein said mat body comprises primarily or substantially exclusively polyester fibers, and has a nominal thickness of about ⅛-1 inch.

22. Media as recited in claim 20 wherein said mat has a unidirectional compression of between about 40-60%

23. Media as recited in claim 20 wherein said media mat has a void volume mean value of about 6-7 times 10⁻⁸ liters.

24. Media as recited in claim 20 comprising about 5-20% zeolite.

25. A vessel capable of holding and dispersing liquid, comprising:
an outer body having a side and a substantially closed bottom;
an inner body spaced from said outer body to define a volume therebetween;
static liquid treatment media disposed within said inner body;
a liquid passageway between said inner body and said volume allowing the flow of liquid from said inner body to said volume, but substantially precluding passage of static treatment media from said inner body to said volume;
a neck or open end at a first end of said bodies through which liquid may enter said inner body;
a closure for said neck or open end; wherein said liquid passageway includes a substantially central portion adjacent said outer body substantially closed bottom; and
a substantially central vent tube extending from a second open end adjacent said vessel neck or open end to a first open end adjacent said liquid passageway central portion, to provide appropriate venting action during discharge from said vessel.

26. A vessel as recited in claim 25 wherein said vent tube has a larger open cross-sectional area adjacent the second end thereof than the first end thereof.

27. A vessel as recited in claim 26 wherein said vent tube has a flare at a point approximately ⅓ the length of said vent tube from said second open end to said second end.

28. A vessel as recited in claim 25 wherein said first end of said vent tube has a hood to minimize or prevent liquid flow into said vent tube.

29. A vessel as recited in claim 28 wherein said hood is connected to an outer supporting element by a plurality of substantially radial support arms, and said outer supporting element operatively connected to said vessel adjacent said neck or open end thereof.

30. A vessel as recited in claim 25 wherein said static filtration media comprises a non-woven mat of a material capable of meeting 21 CFR 177.2260, having a weight of between about 4-7 oz/sq. yd., and a coating comprising about 100-200%, by weight of about 60-85% activated carbon, about 10-20% binder, and about 0-20% zeolite.

31. A vessel as recited in claim 30 wherein said static filtration media has been compressed in one dimension about 25-75% so as to provide a substantially uniform pore size.

32. A vessel as recited in claim 31 wherein said media has an RDV/BV ratio of at least 0.4 and a porosity of at least 90%.

33. A vessel as recited in claim 25 further comprising a secondary particulate filter between said static treatment media and said liquid passageway.

34. A vessel as recited in claim 25 wherein said closure comprises a cap with a manual valve.

35. A vessel as recited in claim 25 wherein said closure comprises a substantially solid screw-on cap.

36. A method of producing a static filtration media comprising:
(a) producing a porous mat of fibers that comply with 21 CFR 177.2260;
(b) applying a coating on the mat including activated carbon and binder;
(c) compressing the mat in one dimension about 25-75% so as to provide a more uniform pore size, by supplying a compression force; and
(d) substantially maintaining the compression force until there is sufficient curing of the binder to minimize recovery of loft following release of the compression force.

37. A method as recited in claim 36 further comprising speeding the cure of the binder using heat or electromagnetic radiation.

38. A method as recited in claim 36 wherein (b) is practiced to applying a coating comprising about 100-200% of the weight of the mat and including, by weight, about 60-85% activated carbon and about 10-20% binder.

39. A method as recited in claim 38 wherein (a) is practiced to produce a non-woven mat.

40. A method as recited in claim 38 wherein (a) is practiced to produce a media having an RDV/BV ratio of at least about 0.4 and a porosity of greater than 90%.

41. A static filtration media comprising a composite structure of activated carbon, ceramic ion-exchangers of either the class of zeolites, or amorphous gels comprised of sodium salts of aluminosilicates or titanium silicates, and a polyester substrate carrier in one of sponge or fiber form, compressed to form a treatment zone so that contaminate molecules suspended in water contained in the treatment zone are within about 0.5 mm of said carbon or zeolite.

42. A media as recited in claim 41 contained in a filter housing which holds between about 8 and 24 ounces of water, said treatment media removing at least about 70% of chlorine and at least about 90% of lead present in untreated water placed in said housing within about 0.1 to 5 minutes of filling of said filter housing.

43. A media as recited in claim 41 contained in a filter housing which holds between about 8 and 24 ounces of water, said treatment media removing at least about 70% of chlorine and at least about 90% of lead present in untreated water placed in said housing within about 0.5 to 2 minutes of filling of said filter housing.

44. A vessel as recited in claim 6 where the media is oriented in the bottle such that the plane of compression is parallel to the flow path of water.
